(19) United States
(12) Patent Application Publication
(10) Pub. No.: US 2007/0141937 A1
(43) Pub. Date: Jun. 21, 2007

(54) Filament-meltblown composite materials, and methods of making same

(76) Inventors: Joerg Hendrix, Alpharetta, GA (US); Braulio A. Polanco, Roswell, GA (US); Bryan J. Stadelman, Alpharetta, GA (US); David W. Hall, Alpharetta, GA (US); Ryan J. McEneany, Appleton, WI (US)

Correspondence Address: Pauley Peterson & Erickson, Suite 365, 2800 West Higgins Road, Hoffman Estates, IL, 60195, US

(21) Appl. No.: 11/304,487

(22) Filed: Dec. 15, 2005

(51) Int. Cl. B32B 27/12; B32B 27/02

(52) U.S. Cl. 442/170; 442/61; 442/65; 442/97; 442/109; 442/164; 156/437

(57) ABSTRACT

An elastic composite material that does not require facing materials. The elastic composite material includes a first elastic meltblown layer, an array of continuous filament strands deposited on the first elastic meltblown layer, and a second elastic meltblown layer deposited on the continuous filaments strands opposite the first elastic meltblown layer. One or both meltblown layers and/or the continuous filament strands may include an elastic polyolefin-based meltblown polymer having a degree of crystallinity between about 3% and about 40%. Also included is a method of making the elastic composite material.

### FIELD OF THE INVENTION

The present invention relates to filament-meltblown composite materials for use on or in various personal care products, and other products requiring stretch capability, and manufacturing methods for making such filament-meltblown composite materials.

### BACKGROUND OF THE INVENTION

Stretch-bonded laminates are commonly used in the manufacture of personal care products to provide stretch capability. The term “stretch-bonded laminate” refers to a composite elastic material made according to a stretch-bonding lamination process, i.e., elastic layer(s) are joined together with additional facing layers when only the elastic layer is in an extended condition (such as by at least about 25 percent of its relaxed length) so that upon relaxation of the layers, the additional layer(s) is/are gathered. Such laminates usually have machine directional (MD) stretch properties and may be subsequently stretched to the extent that the additional (typically non-elastic) material gathered between the bond locations allows the elastic material to elongate. One type of stretch-bonded laminate is disclosed, for example, by U.S. Pat. No. 4,720,415 to Vander Wielen et al., in which multiple layers of the same polymer produced from multiple banks of extruders are used. Other composite elastic materials are disclosed in U.S. Pat. No. 5,385,775 to Wright and copending U.S. Patent Publication No. 2002-0104608, published 8 Aug. 2002, each of which is incorporated by reference herein in its entirety. Such stretch-bonded laminates may include an elastic component that is a web, such as a meltblown web, a film, an array/series of generally parallel continuous filament strands (either extruded or pre-formed), or a combination of such. The elastic layer is bonded in a stretched condition to two inelastic or extendable nonwoven facing materials, such that the resulting laminate is imparted with a textural feel that is pleasing on the hand. In particular, the elastic layer is bonded between the two facing layers, such that the facing layers sandwich the elastic layer. In some instances, the gatherable facing layers may also be necked, such that the stretch-bonded laminate is actually a necked stretch-bonded laminate that may have some extension/elasticity in the cross-machine direction (CD).

Such stretch-bonded laminates may be used to provide elasticity to various components of a personal care product and with the added benefit of a pleasant fabric-like touch, such as a diaper liner or outercover, diaper waist band material, diaper leg gasketing (cuff) material, diaper ear portions (that is, the point of attachment of a fastening system to a diaper), as well as side panel materials for diapers and child training pants. Since such materials often come in contact with skin of a human body, it is desirable that such materials be relatively soft to the touch, rather than rubbery in their feel (a sensation common for elastic materials). Such materials may likewise provide elasticity and comfort for materials that are incorporated into protective workwear, such as surgical gowns, face masks and drapes, labcoats, or protective outercovers, such as car, grill or boat covers.

While such soft and stretchy materials have assisted in making such elastic materials more user-friendly, there is still a need for such products that can be made in an efficient one-step manufacturing process. There is likewise a need for such a laminate material having reduced through-roll aging and variability compared to stretch-bonded laminates. There is likewise a need for a laminate material that provides reduced stiffness as a result of the elimination of facing layers on the laminate. Such a laminate would be more efficient in its use as an elastic material, plus the elimination of facing layers would be cost-effective. Such a laminate could provide ease of use/extension, with better ability to retract since there would be no drag of extra facing layers. Essentially, such a laminate would provide for higher levels of retraction with lower weights of polymer. However, even with all of these perceived benefits, to date an elastic composite material that is free of facing layers has been elusive because of manufacturing challenges.

Many adhesives are typically somewhat elastic themselves, and tend to retain some level of tackiness even after they are dried or cured. As a result, because of their inherent tackiness, it has been necessary, at least with respect to filament, film, and web based stretch-bonded laminates, to utilize facings on both sides of the center elastic component (i.e. filament array), so as to avoid roll blocking during processing/storage. For the purposes of this application, the terms “roll blocking” and “roll sticking” shall be used interchangeably, and shall refer to the propensity of tacky films, tacky filament arrays or other tacky sheet materials to stick to themselves upon being rolled up for storage, prior to final use. Such roll blocking may prevent use of the material contained on a roll as a result of the inability to unwind such rolled material when it is actually needed. In filament-based stretch-bonded laminates, adhesive is often applied to the facing layers themselves, and then the facing layers are combined in a nip with the filament array between them. Such an arrangement may generally be described as an ABA laminate, where A is a facing layer and B is an elastic layer.

While it would be desirable to reduce the basis weight of the stretch-bonded laminate such that the material is less costly and more flexible, it has been heretofore unclear how to eliminate the facing layers without causing the rolled material to stick, if it is to be stored prior to use. It is therefore desirable to have an elastic composite material that is free of facing layers that demonstrates acceptable elastic performance, but that is also capable of being stored on a roll without concern for roll blocking. It is also desirable to have a material that may be maintained on a roll under acceptable storage conditions, such as for a given period of time, and at a range of temperatures. It is to such needs that the current invention is directed.

### SUMMARY OF THE INVENTION

An elastic composite material capable of being rolled for storage, and unwound from a roll when needed for use, includes a first elastic meltblown layer, an elastic layer of an array of continuous filament strands deposited on the first elastic meltblown layer, and a second elastic meltblown layer deposited on the continuous filament strands opposite the first elastic meltblown layer. The elastic composite material includes an elastic polyolefin-based polymer having a degree of crystallinity between about 3% and about 40%, or between about 5% and about 30%. The elastic polyolefin-based polymer may have a melt flow rate between about 10 and about 600 grams per 10 minutes, or between about 60 and about 300 grams per 10 minutes, or between about 150 and about 200 grams per 10 minutes; a melting/softening point between about 40 and about 160 degrees Celsius; and/or a density from about 0.8 to about 0.95, or about 0.85 to about 0.93, or about 0.86 to about 0.89 grams per cubic centimeter. The elastic polyolefin-based polymer may include polyethylene, polypropylene, butene, or octene homo- or copolymers, ethylene methacrylate, ethylene vinyl acetate, butyl acrylate copolymers, or a combination of any of these polymers. The elastic polyolefin-based polymer may be used to form one or both meltblown layers and/or the continuous filament strands.

When at least one of the meltblown layers includes the elastic polyolefin-based polymer, the elastic composite material suitably has an inter-layer peel strength that is less than an inter-layer peel strength of the composite material. For example, when the elastic composite material is rolled upon itself, it can be unwound for future use without the outer surfaces of the material adhering to one another on the roll. Thus, the elastic composite material may not require any post-calender treatment such as a nonblocking agent or the like.

In still a further alternative embodiment, the elastic composite material includes an adhesive between the array of continuous filament strands and at least one of the meltblown layers that demonstrates a relatively short open time, such as an open time of between about 0.2 seconds and 1 minute, or between about 0.2 seconds and 3 seconds, or between about 0.5 seconds and 2 seconds. In still another alternative embodiment, such elastic composite material includes an adhesive between the array of continuous filament strands and at least one of the meltblown layers, wherein the adhesive is applied in an amount less than about 16 gsm, or less than about 8 gsm, or less than about 4 gsm, or between about 1 and 4 gsm.

The first and/or second elastic meltblown layer may be a single layer of meltblown material or, alternatively, may include two or more layers. For example, one of the layers may include an elastic polyolefin-based meltblown polymer having a degree of crystallinity between about 3% and about 40%, or between about 5% and about 30%, and another layer may include a styrenic block copolymer-based meltblown polymer.

In certain embodiments of the invention, the elastic composite material has an overall basis weight between about 10 gsm and 100 gsm, or between about 20 gsm and 90 gsm, or between about 30 gsm and 50 gsm.

The invention also includes a method of producing an elastic composite material. The method includes providing a first elastic meltblown layer, depositing an array of continuous filament strands on the first elastic meltblown layer, and depositing a second elastic meltblown layer on the continuous filament strands opposite the first elastic meltblown layer. The elastic composite material may or may not be calendered. Even though the resulting material has no facing layers covering the elastic composite material, the resulting elastic composite material may be wound on a roll without experiencing roll-blocking.

An elastic composite material, as described herein, for use in a personal care or other stretchable article is also contemplated by the invention. In certain embodiments in particular, the elastic composite material is incorporated into a personal care article adjacent to an opening for a body part.

### BRIEF DESCRIPTION OF THE DRAWINGS

The invention will be better understood by reference to the following description of embodiments of the invention taken in conjunction with the accompanying drawings, wherein:

FIG. 1 illustrates a method of manufacturing an elastic composite material in accordance with the invention.

FIG. 2 illustrates a cross sectional view of one embodiment of an elastic composite material.

FIG. 3 illustrates a cross sectional view of another embodiment of an elastic composite material.

FIG. 4 illustrates an alternative method of manufacturing an elastic composite material in accordance with the invention.

FIG. 5 illustrates a personal care product utilizing an elastic composite material made in accordance with the invention.

### DEFINITIONS

Within the context of this specification, each term or phrase below will include the following meaning or meanings.

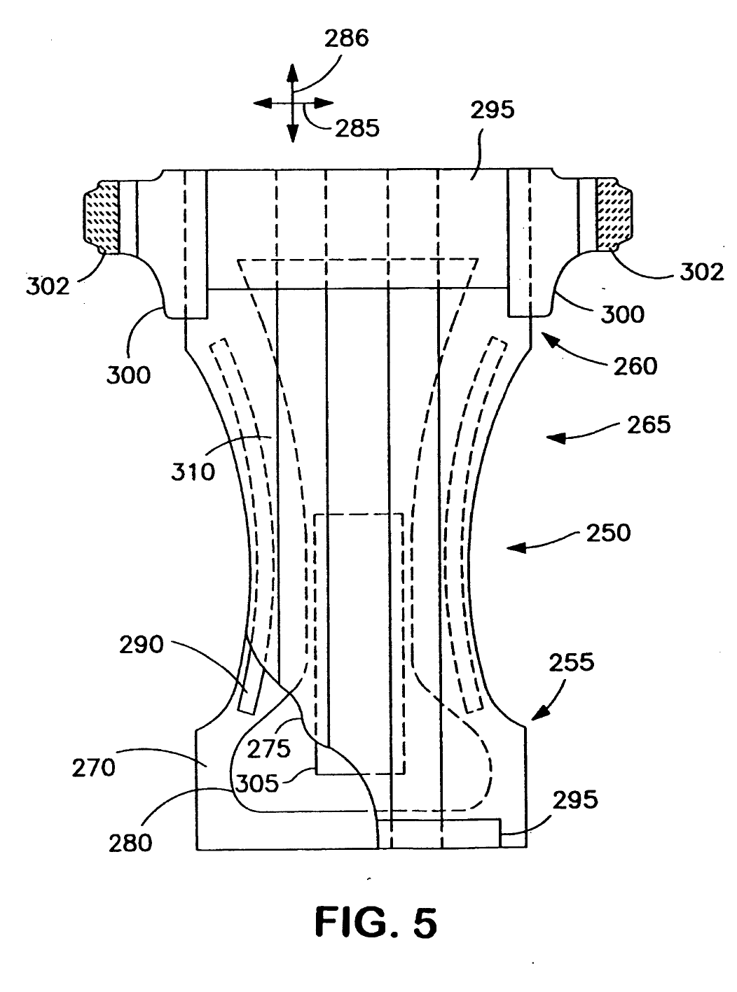

As used herein, the term “personal care article” means diapers, training pants, swimwear, absorbent underpants, adult incontinence products, and feminine hygiene products, such as feminine care pads, napkins and pantiliners. While a diaper is illustrated in FIG. 5, it should be recognized that the inventive material may just as easily be incorporated in any of the previously listed personal care articles as an elastic component. For instance, such material may be utilized to make the elastic side panels of training pants.

As used herein the term “protective outerwear” means garments used for protection in the workplace, such as surgical gowns, hospital gowns, covergowns, labcoats, masks, and protective coveralls.

As used herein, the terms “protective cover” and “protective outercover” mean covers that are used to protect objects such as for example car, boat and barbeque grill covers, as well as agricultural fabrics.

As used herein, the terms “polymer” and “polymeric” when used without descriptive modifiers, generally include but are not limited to, homopolymers, copolymers, such as for example, block, graft, random and alternating copolymers, terpolymers, etc. and blends and modifications thereof. Furthermore, unless otherwise specifically limited, the term “polymer” includes all possible spatial configurations of the molecule. These configurations include, but are not limited to isotactic, syndiotactic and random symmetries.

As used herein, the terms “machine direction” or MD mean the direction along the length of a fabric in the direction in which it is produced. The terms “cross machine direction,” “cross directional,” or CD mean the direction across the width of fabric, i.e. a direction generally perpendicular to the MD.

As used herein, the term “meltblown” means fibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al. incorporated by reference herein in its entirety.

As used herein, the terms “sheet” and “sheet material” shall be interchangeable and in the absence of a word modifier, refer to woven materials, nonwoven webs, polymeric films, polymeric scrim-like materials, and polymeric foam sheeting.

The basis weight of nonwoven fabrics or films is usually expressed in ounces of material per square yard (osy) or grams per square meter (g/m² or gsm) and the fiber diameters are usually expressed in microns. (Note that to convert from osy to gsm, multiply osy by 33.91). Film thicknesses may also be expressed in microns or mil.

As used herein, the term “laminate” refers to a composite structure of two or more sheet material layers that have been adhered through a bonding step, such as through adhesive bonding, thermal bonding, point bonding, pressure bonding, extrusion coating or ultrasonic bonding.

As used herein, the term “elastomeric” shall be interchangeable with the term “elastic” and refers to sheet material which, upon application of a stretching force, is stretchable in at least one direction (such as the CD direction), and which upon release of the stretching force contracts/returns to approximately its original dimension. For example, a stretched material having a stretched length which is at least 50 percent greater than its relaxed unstretched length, and which will recover to within at least 50 percent of its stretched length upon release of the stretching force. A hypothetical example would be a one (1) inch sample of a material which is stretchable to at least 1.50 inches and which, upon release of the stretching force, will recover to a length of not more than 1.25 inches. Desirably, such elastomeric sheet contracts or recovers up to 50 percent of the stretch length in a particular direction, such as in either the machine direction or the cross machine direction. Even more desirably, such elastomeric sheet material recovers up to 80 percent of the stretch length in a particular direction, such as in either the machine direction or the cross machine direction. Even more desirably, such elastomeric sheet material recovers greater than 80 percent of the stretch length in a particular direction, such as in either the machine direction or the cross machine direction. Desirably, such elastomeric sheet is stretchable and recoverable in both the MD and CD directions.

As used herein, the term “elastomer” shall refer to a polymer which is elastomeric.

As used herein, the term “thermoplastic” shall refer to a polymer which is capable of being melt processed.

As used herein, the term “inelastic” or “nonelastic” refers to any material which does not fall within the definition of “elastic” above.

As used herein the term “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30 percent bond area with about 200 bonds/square inch as taught in U.S. Pat. No. 3,855,046 to Hansen and Pennings, incorporated herein by reference in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15 percent. Yet another common pattern is the C-Star pattern which has a bond area of about 16.9 percent. The C-Star pattern has a cross-directional bar or “corduroy” design interrupted by shooting stars. Other common patterns include a diamond pattern with repeating and slightly offset diamonds with about a 16 percent bond area and a wire weave pattern looking as the name suggests, e.g. like a window screen pattern having a bond area in the range of from about 15 percent to about 21 percent and about 302 bonds per square inch.

Typically, the percent bonding area varies from around 10 percent to around 30 percent of the area of the fabric laminate. As is well known in the art, the spot bonding holds the laminate layers together as well as imparts integrity to each individual layer by bonding filaments and/or fibers within each layer.

As used herein, the term “ultrasonic bonding” means a process performed, for example, by passing the fabric between a sonic horn and anvil roll as illustrated in U.S. Pat. No. 4,374,888 to Bornslaeger, incorporated by reference herein in its entirety.

As used herein, the term “adhesive bonding” means a bonding process which forms a bond by application of an adhesive. Such application of adhesive may be by various processes such as slot coating, spray coating and other topical applications. Further, such adhesive may be applied within a product component and then exposed to pressure such that contact of a second product component with the adhesive containing product component forms an adhesive bond between the two components.

As used herein, the term “post-calender treatment” refers to any treatment, such as the application of a nonblocking agent, that is typically applied to a laminate toward the end of the lamination process, such as following the passage of the laminate through a nip or over a calender roll, in order to reduce inter-layer peel strength.

As used herein, the term “inter-layer peel strength” refers to the peel strength required to separate a laminate from itself when unwound from a roll, as opposed to the peel strength between layers within the laminate. Inter-layer peel strength can be determined using the Roll Blocking Test Method described in detail below.

As used herein, and in the claims, the term “comprising” is inclusive or open-ended and does not exclude additional unrecited elements, compositional components, or method steps. Accordingly, such term is intended to be synonymous with the words “has,” “have,” “having,” “includes,” “including,” and any derivatives of these words.

As used herein, the terms “extensible” or “expandable” mean elongatable in at least one direction, but not necessarily recoverable.

Unless otherwise indicated, percentages of components in formulations are by weight.

### DETAILED DESCRIPTION OF THE INVENTION

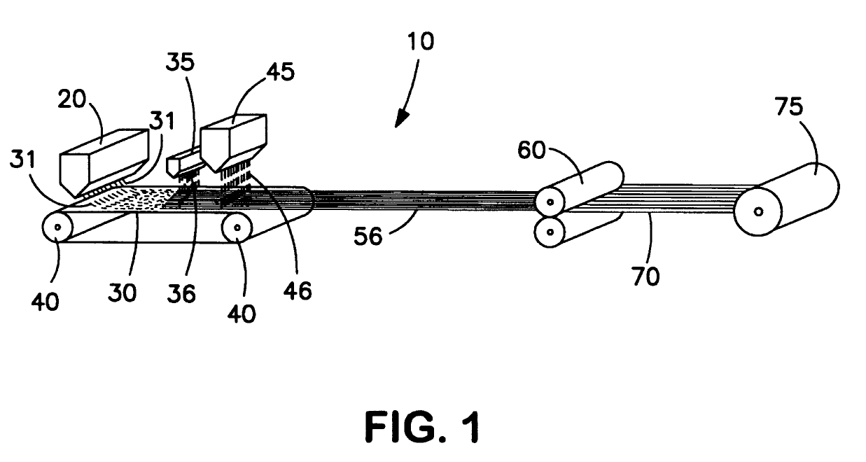

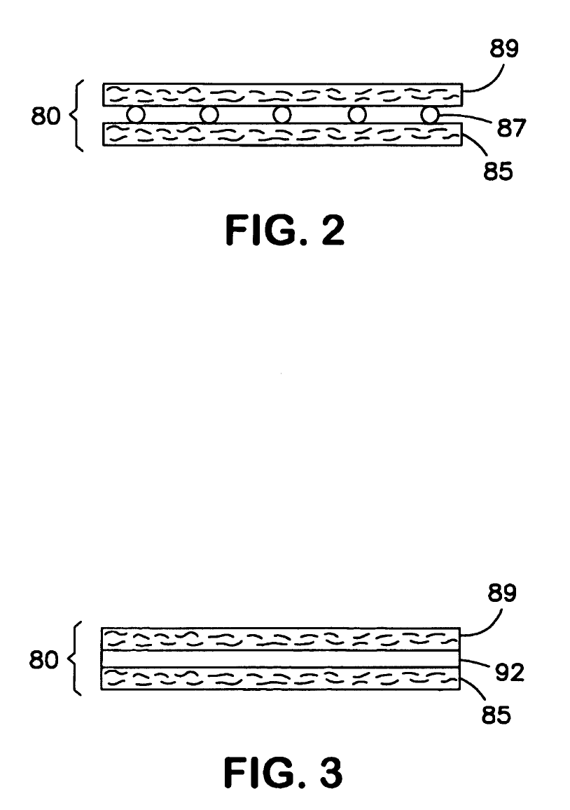

For the purposes of this invention, an elastic composite material includes no facing layers. More particularly, the elastic composite material suitably includes a first elastic meltblown layer, an array of continuous filament strands deposited on the first elastic meltblown layer, and a second elastic meltblown layer deposited on the continuous filament strands opposite the first elastic meltblown layer, as illustrated in FIGS. 1 and 2. Although the elastic composite material has no facing layers, the composite material may be bonded to one or more additional layers to provide elasticity to the additional layers. However, the elastic composite material and the additional layers, when bonded, do not form laminates, per se. More particularly, the additional layers are not co-terminal with the elastic composite material. Instead, it is contemplated that the elastic composite material, free of any facing layers, may be bonded to additional layers to provide elasticity in isolated regions of articles, such as in a personal care article adjacent to an opening for a body part, namely about a waist opening, leg opening, or the like.

The composite material suitably includes an elastic polyolefin-based polymer having a degree of crystallinity between about 3% and about 40%, or between about 5% and about 30%, or between about 15% and about 25%. The elastic polyolefin-based polymer may also have a melt flow rate between about 10 based and about 600 grams per 10 minutes, or between about 60 and about 300 grams per 10 minutes, or between about 150 and about 200 grams per 10 minutes; a melting/softening point between about 40 and about 160 degrees Celsius; and/or a density from about 0.8 to about 0.95, or about 0.85 to about 0.93, or about 0.86 to about 0.89 grams per cubic centimeter. An elastic polyolefin-based polymer possessing some or all of these properties has been shown to reduce or eliminate roll-blocking in the elastic composite materials described herein. The elastic polyolefin-based polymer may include polyethylene, polypropylene, butene, or octene homo- or copolymers, ethylene methacrylate, ethylene vinyl acetate, butyl acrylate copolymers, or a combination of any of these polymers.

One example of a suitable elastic polyolefin-based polymer is VISTAMAXX, such as VM2210, available from ExxonMobil Chemical of Baytown, Texas. Other examples of suitable polyolefin-based polymers include EXACT plastomer, OPTEMA ethylene methacrylate, and VISTANEX polyisobutylene, and metallocene-catalyzed polyethylene, all available from ExxonMobil Chemical, as well as AFFINITY polyolefin plastomers, such as AFFINITY EG8185 or AFFINITY GA1950, available from Dow Chemical Company of Midland, Michigan; ELVAX ethylene vinyl acetate, available from E. I. Du Pont de Nemours and Company of Wilmington, Del.; and ESCORENE Ultra ethylene vinyl acetate, available from ExxonMobil.

The elastic polyolefin-based polymer suitably has a slow crystallization rate, with partial regions of crystalline and amorphous phases that make it inherently elastic and tacky. The elastic polyolefin-based polymer may be incorporated within one or both of the elastic meltblown layers and/or the continuous filament strands, as described in greater detail below.

It is desirable that such elastic composite material demonstrate a stretch-to-stop value of between about 30 and 400 percent. In an alternative embodiment, such material demonstrates a stretch-to-stop value of between about 50 and 300 percent. In still a further alternative embodiment, such composite material demonstrates a stretch-to-stop value of between about 80 and 250 percent.

Additional components may be included in the elastic composite material, such as a film, an elastic scrim or netting structure, a foam material, or a combination of any of the foregoing materials. If a film is used, it may be an apertured film. In certain embodiments, any of these additional components may be used in place of the array of continuous filament strands.

At least one of the components of the elastic composite material may be formed from an elastic polyolefin-based polymer having a degree of crystallinity between about 3% and about 40%, or between about 5% and about 30%, or between about 15% and about 25%, as described above. When the elastic polymer is used to form one or both of the meltblown layers, for example, the slow crystallization rate of the elastic polymer is advantageous because the meltblown fibers are semi-tacky as they are deposited on the forming wire, which keeps the elastic strands in place and adhesively bonds the composite. Additionally, when the meltblown layer(s) includes the elastic polymer, the meltblown layer(s) may be applied at a higher add-on compared to non-elastic meltblown layers. Furthermore, the higher add-on of elastic meltblown coupled with the tackiness of the elastic meltblown helps to better secure the filaments between the meltblown layers such that the filaments are less likely to come loose, as demonstrated by inter-layer peel strength that is greater than intra-layer peel strength. More particularly, the peel strength of the components within the composite is greater than the peel strength of the exterior surfaces of the composite to itself when the composite material is unwound from a roll. The higher add-on of elastic meltblown may also help reduce porosity compared to conventional stretch-bonded laminates of a comparable total basis weight manufactured with spunbond facings.

Another benefit of using the elastic polyolefin-based polymer in the meltblown layer is the reduction or elimination of roll blocking, as demonstrated through the low inter-layer peel strength of the composite material. In addition to preventing blocking in rolls, the elastic polyolefin-based polymer will also stretch with the elastic filament strands. Other laminates may include post-calender treatment, such as non-elastic polypropylene meltblown dusting, to prevent roll blocking, but the incorporation of the elastic polymer in the meltblown layer may remove the need for any post-calender treatment.

One or both of the meltblown layers may include, for example, between about 30% and about 100%, or between about 50% and about 80%, by weight elastic polyolefin-based polymer. One or both of the meltblown layers may be a single layer or a multi-layer component. For example, the meltblown layer(s) may also include a layer of styrenic block copolymer-based meltblown polymer, as described in greater detail below.

As mentioned, the continuous filament strands may also include an elastic polyolefin-based polymer. More particularly, the continuous filament strands may be composed of between about 5% and about 90%, or between about 30% and about 70%, by weight elastic polyolefin-based polymer.

Furthermore, any or all of the components within the elastic composite material (whether the meltblown layer(s), the filaments, or other components) may include thermoplastic materials such as block copolymers having the general formula A-B-A′ where A and A′ are each a thermoplastic polymer endblock which contains a styrenic moiety such as a poly (vinyl arene) and where B is an elastomeric polymer midblock such as a conjugated diene or a lower alkene polymer.

Specific examples of useful styrenic block copolymers include hydrogenated polyisoprene polymers such as styrene-ethylenepropylene-styrene (SEPS), styrene-ethylenepropylene-styrene-ethylenepropylene (SEPSEP), hydrogenated polybutadiene polymers such as styrene-ethylenebutylene-styrene (SEBS), styrene-ethylenebutylene-styrene-ethylenebutylene (SEBSEB), styrene-butadiene-styrene (SBS), styrene-isoprene-styrene (SIS), and hydrogenated poly-isoprene/butadiene polymer such as styrene-ethylene-ethylenepropylene-styrene (SEEPS). Polymer block configurations such as diblock, triblock, multiblock, star and radial are also contemplated in this invention. In some instances, higher molecular weight block copolymers may be desirable. Block copolymers are available from Kraton Polymers U.S. LLC of Houston, Tex., under the designations Kraton G or D polymers, for example G1652, G1657, G1730, D1114, D1155, D1102 and Septon Company of America, Pasadena, Tex., under the designations Septon 2004, Septon 4030, and Septon 4033. Other potential suppliers of such polymers include Dexco Polymers of Texas and Dynasol of Spain. Blends of such elastomeric resin materials are also contemplated as the primary component of the elastic layer. Additionally, other desirable block copolymers are disclosed in U.S. Patent Publication 2003/0232928A1 which is incorporated by reference herein in its entirety.

Such base resins may be further combined with tackifiers and/or processing aids in compounds. Exemplary compounds include but are not limited to KRATON G 2760, and KRATON G 2755. Processing aids that may be added to the elastomeric polymer described above include a polyolefin to improve the processability of the composition. The polyolefin must be one which, when so blended and subjected to an appropriate combination of elevated pressure and elevated temperature conditions, is extrudable, in blended form, with the elastomeric base polymer. Useful blending polyolefin materials include, for example, polyethylene, polypropylene and polybutene, including ethylene copolymers, propylene copolymers and butene copolymers. A particularly useful polyethylene may be obtained from Eastman Chemical under the designation EPOLENE C-10. Two or more of the polyolefins may also be utilized. Extrudable blends of elastomeric polymers and polyolefins are disclosed in, for example, U.S. Pat. No. 4,663,220, hereby incorporated by reference in its entirety.

The elastomeric filaments may have some tackiness/adhesiveness to enhance autogenous bonding. For example, the elastomeric polymer itself may be tacky when formed into films, and/or filaments or, alternatively, a compatible tackifying resin may be added to the extrudable elastomeric compositions described above to provide tackified elastomeric fibers and/or filaments that autogenously bond. In regards to the tackifying resins and tackified extrudable elastomeric compositions, note the resins and compositions as disclosed in U.S. Pat. No. 4,787,699, hereby incorporated by reference in its entirety.

Any tackifier resin can be used which is compatible with the elastomeric polymer and can withstand the high processing (e.g. extrusion) temperatures. If the elastomeric polymer (e.g. A-B-A elastomeric block copolymer) is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ series tackifiers are examples of such hydrogenated hydrocarbon resins. REGALREZ hydrocarbon resins are available from Eastman Chemical. Of course, the present invention is not limited to use of such tackifying resins, and other tackifying resins that are compatible with the other components of the composition and can withstand the high processing temperatures can also be used. Other tackifiers are available from ExxonMobil under the ESCOREZ designation.

Other exemplary elastomeric materials that may be used include polyurethane elastomeric materials such as, for example, those available under the trademark ESTANE from Noveon, polyamide elastomeric materials such as, for example, those available under the trademark PEBAX (polyether amide) from Ato Fina Company, and polyester elastomeric materials such as, for example, those available under the trade designation HYTREL from E. I. DuPont De Nemours & Company.

Useful elastomeric polymers also include, for example, elastic polymers and copolymers of ethylene and at least one vinyl monomer such as, for example, vinyl acetates, unsaturated aliphatic monocarboxylic acids, and esters of such monocarboxylic acids. The elastic copolymers and formation of elastomeric meltblown fibers from those elastic copolymers are disclosed in, for example, U.S. Pat. No. 4,803,117, incorporated by reference herein in its entirety.

Additional materials which may be utilized in the elastic composite material, such as in the meltblown layers and/or the continuous filament strands, to provide some extensibility with limited recovery, include single site catalyzed polyolefinic materials, such as metallocene catalyzed polyolefins and constrained geometry polyolefins, as available from Dow under the designation AFFINITY and from ExxonMobil, under the designation EXACT. Desirably, such materials have densities of less than 0.89 g/cc.

Finally, pre-formed elastic strands are also contemplated to be within the scope of this invention. Such pre-formed strands, such as solution-treated materials, include LYCRA, available from Invista of Wichita, Kans.; GLOSPAN, available from Globe Manufacturing Co. of Fall River, Mass.; and FULFLEX, available from Fulflex Elastomerics Worldwide of Lincoln, Rhode Island. This material may serve as the basis for a continuous filament array component, or alternatively a film component, of the elastic composite material.

The filaments, whether extruded or pre-formed, may be round with a circular cross-section, or may have various other cross-sectional shapes. For example, certain embodiments may include strips or flat strands, having a square, rectangular, or other cross-sectional shape that lends a flat appearance to the strands. Flat strands may provide better control during winding, for example.

Typically, the blend used to form the web, film or filaments when such is made from an extruded material in an on-line process, includes for example, from about 40 to about 90 percent by weight elastomeric polymer base resin, from about 0 to about 40 percent polyolefin processing aid, and from about 5 to about 40 percent resin tackifier. These ratios can be varied depending on the specific properties desired and the polymers utilized. For an alternative embodiment, such blend includes between about 60 and 80 percent base resin, between about 5 to 30 percent processing aid, and between about 10 and 30 percent tackifier. In a further alternative embodiment, such blend includes a tackifier in an amount of between about 10 and 20 percent tackifier.

The elastic composite material can be made using various methods. In particular, the material may be made using either an extrusion and bonding method with an elastic polyolefin-based meltblown layer having a slow rate of crystallization, or an application of a pre-bonding adhesive that has a relatively low open time and a post-bonding application of such an adhesive, with the adhesive becoming non-tacky following application. The various methods may be described in one embodiment as involving a bonding agent, even though all of the methods do not involve “adhesives” per se. The methods can be variously characterized as involving mechanical entanglement which, in effect, mechanically bonds layers together without a tacky result.

The attributes of a semi-tacky elastic polyolefin-based meltblown layer having a slow rate of crystallization are described above. More particularly, the meltblown fibers are semi-tacky when deposited on the forming wire, which keeps the elastic strands in place and adhesively bonds the composite. Additionally, the elastic meltblown layers can be applied at a relatively high add-on, which contributes to the bonding between the meltblown layers and the filaments.

If an adhesive method is used to create such elastic composite materials, it is desirable that such adhesive have a relatively short open time of between about 0.2 seconds (sec) and 1 minute. In an alternative embodiment, such open time is between about 0.2 sec and 3 sec. In still a further alternative embodiment, such open time is between about 0.5 sec and 2 sec. An exemplary adhesive with such properties is a polypropylene-based hot melt adhesive (that becomes nontacky shortly after application, upon solidification) including up to 65 percent or between about 15-40 percent atactic polypropylene, in one embodiment about 50 weight percent Huntsman H2115 (atactic polypropylene from Huntsman Polymers); between about 20-50 percent tackifier, in one embodiment about 30 percent ExxonMobil ESCOREZ 5300; between about 2-10 percent styrenic block copolymer, in one embodiment about 4 percent SEPTON 2002 from Septon Polymers; between about 10-20 percent isotactic polypropylene, in one embodiment, about 16 percent PP 3746G (isotactic polypropylene) also from ExxonMobil; between about 0-2 percent coloring agent, in one embodiment about 2 percent of a coloring agent, such as 50 percent titanium dioxide in VECTOR 4411 and finally; between about 0.2-1 percent stabilizer, in one embodiment, about 0.5 percent IRGANOX 1010 from Ciba Specialty Chemicals. It should be appreciated that the various components may have other substitutes, such as stabilizers other than IRGANOX. Furthermore, it should be appreciated that such adhesives may also not contain coloring agents, depending on product application. Other adhesives may be used with the present invention including those derived from the adhesives described in U.S. Pat. Nos. 6,657,009; 6,774,069; and 6,872,784, and U.S. Pat. Publication Nos. 20020123538 and 20050054779, each of which is incorporated herein by reference in its entirety.

In one embodiment, it is desirable that the adhesive be applied in a pre-bonding step (that is prior to (such as immediately prior to) bringing the meltblown layers and the continuous filament strands together in a nip) at a basis weight of less than about 16 gsm. In an alternative embodiment, such adhesive is applied at a basis weight of less than about 8 gsm. In still a further alternative embodiment, it is desirable that such adhesive be applied at a basis weight of less than about 4 gsm. In still a further alternative embodiment, it is desirable that the adhesive be applied at between 1 and 4 gsm. In one embodiment, it is desirable that such adhesive be applied by spray, such as through systems available from ITW or other such spray applications. Such spray application is in one embodiment sprayed onto one of the layers, such as on one of the meltblown layers. In an alternative embodiment, such spray is into the nip at which the meltblown layers and the continuous filament strands are joined.

If the adhesive is to be applied as a pre-bonding and post-bonding step (pre-bonding as previously described), it is desirable that the adhesive be applied on the materials (as will be described below) in an amount of less than 4 gsm prior to bonding of the various layers. In an alternative embodiment, such adhesive is desirably applied in an amount of less than 2 gsm prior to bonding of the various layers. In still another alternative embodiment, such adhesive is applied in a pre-bonding step in a range of between about 1 and 4 gsm and in a post-bonding step of between about 0-4 gsm.

In one embodiment, a method for producing an elastic composite material utilizes two meltblown layers such as those which have been previously described, and an array of continuous elastic filaments bonded between the meltblown layers, such that the composite has a structure of ABA, in which the “A” represents the elastic meltblown layers, and the “B” represents the continuous elastic filaments. In such a fashion the resulting material demonstrates increased stretch levels, as well as the ability of the material to be rolled for storage over itself if it is not to be used immediately. The material likewise demonstrates enhanced elastic retraction force per given basis weight since the elastic composite material is allowed to retract to a greater extent than would be possible with one or two facing layers attached.

As can be seen in FIG. 1, which illustrates a schematic view of a method for manufacturing an elastic composite material in accordance with the invention, FIG. 1 illustrates a horizontal, continuous filament laminate manufacturing process 10. A first meltblown bank 20 is fed with a polymer blend composition, such as the materials previously described, particularly an elastic polyolefin-based polymer, from one or more sources (not shown), which is extruded onto a forming surface 30 (e.g., a foraminous belt) moving clockwise about rollers 40 in the form of a first meltblown layer 31. A vacuum (not shown) can also help hold the meltblown fibers 31 against the foraminous wire system. Techniques for fiber extrusion, such as modified meltblowing of the fibers, are further set forth in the previously mentioned U.S. Pat. No. 5,385,775 to Wright.

An array of continuous filaments 36 is extruded from a filament extrusion bank 35 onto the first meltblown layer 31 on the forming surface 30. The extruded polymer is desirably a styrenic block copolymer elastomer and/or an elastic polyolefin-based polymer. In various embodiments, the extrusion apparatus 35, or an additional adjacent extrusion apparatus (not shown), can be configured to produce other materials, e.g. a film, to achieve the inline placement of layers of the same or different materials.

A second meltblown layer 46, also of an elastomeric material such as the materials previously described, particularly an elastic polyolefin-based polymer, is extruded from a second meltblown bank 45, such that the meltblown fibers 46 are placed on top of the continuous filaments 36 (array).

In one embodiment, each of the meltblown layers 31, 46 is applied such that the combined meltblown layers represent about 30 to about 90 basis weight percent of the elastic composite material 70, for example. In a particular embodiment, the elastic polyolefin-based polymer composition is the same in both the filaments 36 and meltblown materials 31, 46. In an alternative embodiment, the compositions are different (which may include the same base resin, but different percentages of processing aid or tackifiers).

The filament/meltblown composite is pulled off the forming surface 30 and may be calendered through a pair of nip rolls 60 with minimal draw. More particularly, depending on the materials used, calendering may not be necessary. Alternatively, the composite material 70 may be lightly calendered using, for example, a rubber/steel laminating nip of approximately 25 pli with a 0.25-0.5 inch nip width. The nip rolls 60 may be smooth and are suitably provided with a surface having little to no affinity for the filaments or fibers. More particularly, the nip rollers 60 may be designed to provide a 100 percent bond area through the use of flat calender rolls or may provide a patterned bond area. The rollers 60 can be heated to a degree below the melting/softening points of the various composite components, or may be ambient, or chilled.

After the combined meltblown layers and continuous filament strands exit the nip 60, the elastic composite material 70 is then conveyed with minimal draw to a collection roll 75 where the material is wound and stored for further use. All rolls that come into contact with the meltblown layers may include a non-stick surface, such as a coating of PTFE (TEFLON), or silicone rubber, release coating. Such rolls may further be coated with IMPREGLON coatings of Southwest Impreglon, of Houston, Tex., or Stowe-Woodward Silfex silicone rubber coatings of a hardness of 60 Shore A. In an alternative embodiment of this continuous filament array composite method, rather than extruding continuous filaments, preformed elastic strands such as LYCRA strands may be unwound from a drum and fed into a calender nip under minimal tension.

The resulting elastic composite material 70 can be manufactured in a one-step process at a lower cost than conventional stretch-bonded laminates because no facing materials are required, thereby streamlining the manufacturing process and reducing material costs. Furthermore, the elastic composite material can be wound on a roll under minimal tension, potentially minimizing through-roll aging and through-roll variability that is typically associated with stretch-bonded laminates.

Other methods of making the elastic composite material 70 may include more than one step. For example, one or both layers of meltblown may be pre-formed and unwound from rolls. Additionally, the elastic filaments 36 may be pre-formed rather than extruded during the formation of the elastic composite material 70. Thus, the various methods may include two extruded layers of meltblown and extruded filaments; two extruded layers of meltblown and pre-formed filaments; two pre-formed layers of meltblown and extruded filaments; two pre-formed layers of meltblown and pre-formed filaments; one extruded layer of meltblown with one pre-formed layer of meltblown and extruded filaments; or one extruded layer of meltblown with one pre-formed layer of meltblown and pre-formed filaments. As described herein, additional layers may also be included, and other forms of the elastic middle layer, such as film, may be used in place of the filaments.

A structure of the elastic composite material can be seen in FIG. 2, which illustrates a cross sectional stylistic view of an elastic composite material 80 in accordance with the invention. As can be seen in the figure, the first elastic meltblown layer 85 may be situated under/immediately adjacent the filament array 87. The second elastic meltblown layer 89 is positioned on top of the filament array 87 on a side opposite to that of the first elastic meltblown layer 85. The thicknesses of the various layers are not necessarily to scale, and are exaggerated to illustrate their existence.

In one embodiment, the continuous filaments in such laminates are desirably present in an amount between about 7 to 18, or about 8 to 15 per cross-directional inch. The basis weight of the meltblown material from the first elastic meltblown bank may be up to about 34 gsm, or between about 2 and 20 gsm, at the point of lamination. Similarly, the basis weight of the meltblown material from the second elastic meltblown bank may be up to about 34 gsm, or between about 2 and 20 gsm, at the point of lamination.

As an example of one embodiment of the invention, an ABA structure composite may be produced in accordance with the methods described above, with elastic components A and B, which desirably comprise the elastic meltblown layers and the filament array, each desirably including an elastic polyolefin-based polymer, such as VISTAMAXX available from ExxonMobil. Desirably, such polymeric blend also includes a KRATON G polymeric compounded blend such as KRATON G 2760 or KRATON G 2755 in the filaments, and either the same polymeric blend in the elastic meltblown layers or a second G polymer blend in the meltblown layers. The filaments to meltblown weight ratio may be in a 90:10 ratio, or other suitable ratio.

Alternatively, instead of being a filament array, component B may be a film 92, as illustrated in FIG. 3. In yet another embodiment, component B may include both a filament array and a film (not shown). The film 92 may include an elastic polyolefin-based polymer. Examples of other suitable film materials include any of the elastomeric polymers described herein, particularly those described with respect to the filament array in previous embodiments, provided the film has a basis weight of about 50 gsm or less, or between about 35 to about 45 gsm, or between about 38 and about 42 gsm.

In manufacturing the material for examples, the following conditions were employed. A first meltblown layer was made with VISTMAXX VM2210 at a basis weight of approximately 33 gsm (1 pound per inch per hour (PIH) at 30 feet per minute (fpm)). The first meltblown layer was unwound and KRATON G2760 filaments were extruded at 475 degrees Fahrenheit melt temperature at a rate of 0.5 PIH onto the first meltblown layer, resulting in a filament basis weight of approximately 16 gsm. This material was then passed under another meltblown bank that extruded a second meltblown layer of VISTAMAXX VM2210 at approximately 1.0 PIH (32 gsm) over the filaments, resulting in a final composite basis weight of approximately 82 gsm. The extrusion temperature for the VISTAMAXX VM2210 was 450 degrees Fahrenheit. In an alternative embodiment of a method for making an elastic composite material, a vertical oriented extrusion platform may be used to extrude an elastic continuous filament array. In this embodiment, a non-tacky adhesive bonding method may be employed to bond the elastic continuous filament array to the meltblown layers.

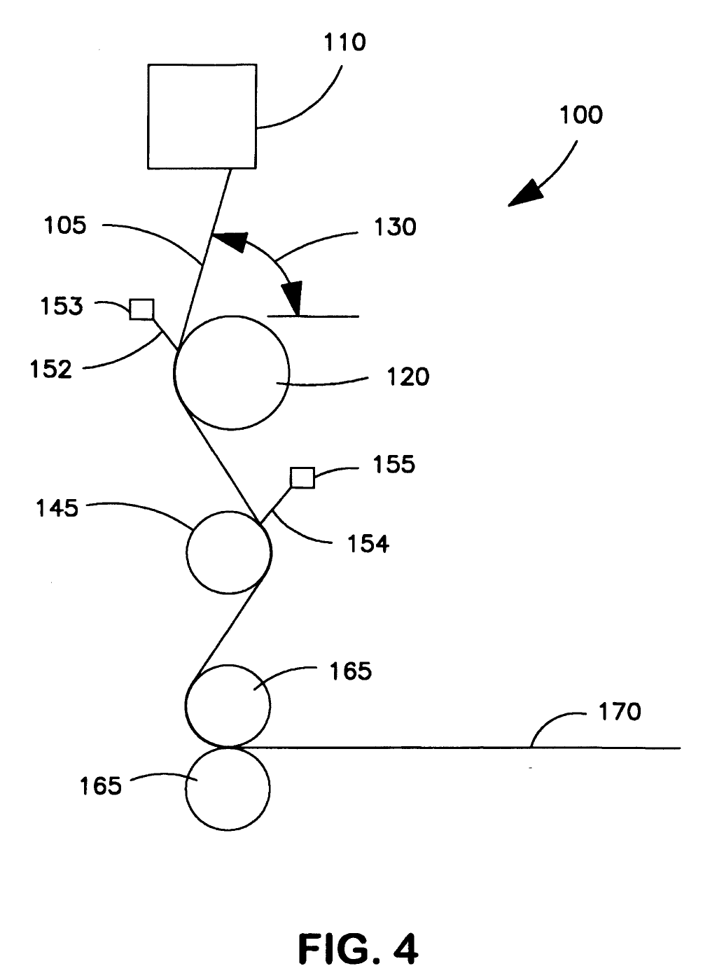

FIG. 4 schematically illustrates a vertical filament laminate manufacturing process 100 for the manufacture of elastic composite materials 170 produced from an elastic composition. Referring to FIG. 4, at least one molten elastomeric material 105, i.e. a styrenic block co-polymer material, is extruded from a die extruder 110 through spinning holes as a plurality of substantially continuous elastomeric filaments. The extruder may extrude at temperatures between about 360 and 500° F. A film die for producing sheets or ribbons may also be used in alternative embodiments. The filaments 105 are quenched and solidified by passing the filaments 105 over a first roll 120. The first roll 120 may be a chill roll. Any number of chill rolls can be used. Suitably, chill rolls may have a temperature of between about 40° F. to about 80° F. Alternatively, as shown in FIG. 4, the first roll 120 may be a vacuum roll upon which the first layer of meltblown may be deposited, as described in further detail below.

The die of the extruder 110 may be positioned with respect to the first roll 120 so that the continuous filaments meet this first roll 120 at a predetermined angle 130. This strand extrusion geometry is particularly advantageous for depositing a melt extrudate onto a rotating roll or drum. An angled, or canted orientation provides an opportunity for the filaments to emerge from the die at a right angle to the roll tangent point, resulting in improved spinning, more efficient energy transfer, and generally longer die life. This configuration allows the filaments to emerge at an angle from the die and follow a relatively straight path to contact the tangent point on the roll surface. The angle 130 between the die exit of the extruder 110 and the vertical axis (or the horizontal axis of the first roll, depending on which angle is measured) may be as little as a few degrees or as much as 90 degrees. For example, a 90 degree extrudate exit to roll angle could be achieved by positioning the extruder 110 directly above the downstream edge of the first roll 120 and having a side exit die tip on the extruder. Moreover, angles such as about 20 degrees, about 35 degrees, or about 45 degrees, away from vertical may be utilized. It has been found that, when utilizing a 12-filament/inch spinplate hole density, an approximately 45 degree angle (shown in FIG. 4) allows the system to operate effectively. The optimum angle, however, may vary as a function of extrudate exit velocity, roll speed, vertical distance from the die to the roll, and horizontal distance from the die centerline to the top dead center of the roller. Optimal performance can be achieved by employing various geometries to result in improved spinning efficiency and reduced filament breakage.

The meltblown layers 152, 154 may be applied to the filaments from meltblown banks 153, 155 on opposite sides of the filaments 105, as shown in FIG. 4. More particularly, the first meltblown layer 152 may be applied from meltblown bank 153 onto vacuum roll 120. The first meltblown layer 152 and the filaments 105 may then pass to vacuum roll 145 upon which the second meltblown layer 154 may be applied from meltblown bank 155. The filaments and meltblown layers are thus combined to form the elastic composite material.

The composite material is then passed through nip rolls 165 to join the elastic filaments 105 and the meltblown layers 152, 154, thereby forming the finished composite material 170.

While calendering the composite material is entirely optional, the nip rollers may be designed to provide a patterned roller which may yield certain benefits such as increased bulk or stretching of the composite material and may be used where the strength of the contact adhesion between the meltblown layers and the strands is not unduly affected. The calender rolls can be heated to a degree below the melting/softening points of the various composite components, or may be ambient, or chilled.

Such elastic composite materials have particular effectiveness for use in personal care products to provide elastic attributes to such products. Such elastic composite materials can provide higher extensibility in either the MD or CD direction than a laminate with facings applied to one or both surfaces of an elastic layer, and can also provide a softer feel.

Such elastic composite material may be useful in providing elastic waist, leg cuff/gasketing, stretchable ear, side panel or stretchable outer cover applications. More particularly, the elastic composite material may beneficially be incorporated into a personal care article adjacent to an opening for a body part. While not intending to be limiting, FIG. 5 is presented to illustrate the various components of a personal care product, such as a diaper, that may take advantage of such elastic materials. Other examples of personal care products that may incorporate such materials are training pants (such as in side panel materials) and feminine care products. By way of illustration only, training pants suitable for use with the present invention and various materials and methods for constructing the training pants are disclosed in PCT Patent Application WO 00/37009 published Jun. 29, 2000 by A. Fletcher et al; U.S. Pat. No. 4,940,464 issued Jul. 10, 1990 to Van Gompel et al.; U.S. Pat. No. 5,766,389 issued Jun. 16, 1998 to Brandon et al.; and U.S. Pat. No. 6,645,190 issued Nov. 11, 2003 to Olson et al., which are each incorporated herein by reference in its entirety.

With reference to FIG. 5, the disposable diaper 250 generally defines a front waist section 255, a rear waist section 260, and an intermediate section 265 which interconnects the front and rear waist sections. The front and rear waist sections 255 and 260 include the general portions of the diaper which are constructed to extend substantially over the wearer's front and rear abdominal regions, respectively, during use. The intermediate section 265 of the diaper includes the general portion of the diaper that is constructed to extend through the wearer's crotch region between the legs. Thus, the intermediate section 265 is an area where repeated liquid surges typically occur in the diaper.

The diaper 250 includes, without limitation, an outer cover, or backsheet 270, a liquid permeable bodyside liner, or topsheet, 275 positioned in facing relation with the backsheet 270, and an absorbent core body, or liquid retention structure, 280, such as an absorbent pad, which is located between the backsheet 270 and the topsheet 275. The backsheet 270 defines a length, or longitudinal direction 286, and a width, or lateral direction 285 which, in the illustrated embodiment, coincide with the length and width of the diaper 250. The liquid retention structure 280 generally has a length and width that are less than the length and width of the backsheet 270, respectively. Thus, marginal portions of the diaper 250, such as marginal sections of the backsheet 270 may extend past the terminal edges of the liquid retention structure 280. In the illustrated embodiments, for example, the backsheet 270 extends outwardly beyond the terminal marginal edges of the liquid retention structure 280 to form side margins and end margins of the diaper 250. The topsheet 275 is generally coextensive with the backsheet 270 but may optionally cover an area which is larger or smaller than the area of the backsheet 270, as desired.

To provide improved fit and to help reduce leakage of body exudates from the diaper 250, the diaper side margins and end margins may be elasticized with suitable elastic members, as further explained below. For example, as representatively illustrated in FIG. 5, the diaper 250 may include leg elastics 290 which are constructed to operably tension the side margins of the diaper 250 to provide elasticized leg bands which can closely fit around the legs of the wearer to reduce leakage and provide improved comfort and appearance. Waist elastics 295 are employed to elasticize the end margins of the diaper 250 to provide elasticized waistbands. The waist elastics 295 are configured to provide a resilient, comfortably close fit around the waist of the wearer.

The elastic composite materials of the inventive structure and methods are suitable for use as the leg elastics 290 and waist elastics 295. Exemplary of such materials are composite sheets that either comprise or are adhered to the backsheet, such that elastic constrictive forces are imparted to the backsheet 270.

As is known, fastening means, such as hook and loop fasteners, may be employed to secure the diaper 250 on a wearer. Alternatively, other fastening means, such as buttons, pins, snaps, adhesive tape fasteners, cohesives, fabric-and-loop fasteners, or the like, may be employed. In the illustrated embodiment, the diaper 250 includes a pair of side panels 300 (or ears) to which the fasteners 302, indicated as the hook portion of a hook and loop fastener, are attached. Generally, the side panels 300 are attached to the side edges of the diaper in one of the waist sections 255, 260 and extend laterally outward therefrom. The side panels 300 may be elasticized or otherwise rendered elastomeric by use of an elastic composite material made from the inventive structure. Examples of absorbent articles that include elasticized side panels and selectively configured fastener tabs are described in PCT Patent Application No. WO 95/16425 to Roessler; U.S. Pat. No. 5,399,219 to Roessler et al.; U.S. Pat. No. 5,540,796 to Fries; and U.S. Pat. No. 5,595,618 to Fries each of which is hereby incorporated by reference in its entirety.

The diaper 250 may also include a surge management layer 305, located between the topsheet 275 and the liquid retention structure 280, to rapidly accept fluid exudates and distribute the fluid exudates to the liquid retention structure 280 within the diaper 250. The diaper 250 may further include a ventilation layer (not illustrated), also called a spacer, or spacer layer, located between the liquid retention structure 280 and the backsheet 270 to insulate the backsheet 270 from the liquid retention structure 280 to reduce the dampness of the garment at the exterior surface of a breathable outer cover, or backsheet, 270. Examples of suitable surge management layers 305 are described in U.S. Pat. No. 5,486,166 to Bishop and U.S. Pat. No. 5,490,846 to Ellis.

As representatively illustrated in FIG. 5, the disposable diaper 250 may also include a pair of containment flaps 310 which are configured to provide a barrier to the lateral flow of body exudates. The containment flaps 310 may be located along the laterally opposed side edges of the diaper adjacent the side edges of the liquid retention structure 280. Each containment flap 310 typically defines an unattached edge which is configured to maintain an upright, perpendicular configuration in at least the intermediate section 265 of the diaper 250 to form a seal against the wearer's body. The containment flaps 310 may extend longitudinally along the entire length of the liquid retention structure 280 or may only extend partially along the length of the liquid retention structure. When the containment flaps 310 are shorter in length than the liquid retention structure 280, the containment flaps 310 can be selectively positioned anywhere along the side edges of the diaper 250 in the intermediate section 265. Such containment flaps 310 are generally well known to those skilled in the art. For example, suitable constructions and arrangements for containment flaps 310 are described in U.S. Pat. No. 4,704,116 to K. Enloe.

The diaper 250 may be of various suitable shapes. For example, the diaper may have an overall rectangular shape, T-shape or an approximately hour-glass shape. In the shown embodiment, the diaper 250 has a generally I-shape. Other suitable components which may be incorporated on absorbent articles of the present invention may include waist flaps and the like which are generally known to those skilled in the art. Examples of diaper configurations suitable for use in connection with the instant invention which may include other components suitable for use on diapers are described in U.S. Pat. No. 4,798,603 to Meyer et al.; U.S. Pat. No. 5,176,668 to Bemardin; U.S. Pat. No. 5,176,672 to Bruemmer et al.; U.S. Pat. No. 5,192,606 to Proxmire et al. and U.S. Pat. No. 5,509,915 to Hanson et al. each of which is hereby incorporated by reference in its entirety.

The various components of the diaper 250 are assembled together employing various types of suitable attachment means, such as adhesive bonding, ultrasonic bonding, thermal point bonding or combinations thereof. In the shown embodiment, for example, the topsheet 275 and backsheet 270 may be assembled to each other and to the liquid retention structure 280 with lines of adhesive, such as a hot melt, pressure-sensitive adhesive. Similarly, other diaper components, such as the elastic members 290 and 295, fastening members 302, and surge layer 305 may be assembled into the article by employing the above-identified attachment mechanisms.

It should be appreciated that such elastic composite materials may likewise be used in other personal care products, protective outerwear, protective coverings and the like. Further such materials can be used in bandage materials for both human and animal bandaging products. Use of such materials provide acceptable elastic performance at a lower manufacturing cost.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

### Test Method Procedures

Stretch-to-Stop Test

“Stretch-to-stop” refers to a ratio determined from the difference between the unextended dimension of a stretchable material and the maximum extended dimension of a stretchable material upon the application of a specified tensioning force and dividing that difference by the unextended dimension of the stretchable material. If the stretch-to-stop is expressed in percent, this ratio is multiplied by 100. For example, a stretchable material having an unextended length of 5 inches (12.7 cm) and a maximum extended length of 10 inches (25.4 cm) upon applying a force of 750 grams has a stretch-to-stop (at 750 grams) of 100 percent. Stretch-to-stop may also be referred to as “maximum non-destructive elongation.” Unless specified otherwise, stretch-to-stop values are reported herein at a load of 750 grams. In the elongation or stretch-to-stop test, a 3-inch by 7-inch (7.62 cm by 17.78 cm) sample, with the larger dimension being the machine direction, the cross direction, or any direction in between, is placed in the jaws of a Sintech machine using a gap of 5 cm between the jaws. The sample is then pulled to a stop load of 750 gms with a crosshead speed of about 20 inches/minute (50.8 cm/minute). For the stretchable material of this invention, it is desirable that it demonstrate a stretch-to-stop value between about 30-400 percent, alternatively between about 50 and 300 percent, still in a further alternative, between about 80-250 percent. The stretch-to-stop test is done in the direction of extensibility (stretch). Depending upon the material being tested, a greater applied force may be more appropriate. For example, for an elastic composite material the applied force of 750 grams per 3 inch cross-directional width is typically appropriate; however, for certain laminates, particularly higher basis weight laminates, an applied force between 750 and 2000 grams per 3 inch cross-directional width may be most appropriate.

Roll-Blocking Test Method (for Inter-layer Peel Strength of Laminate Layers Off of a Roll)

To carry out the roll-blocking test, cut an approximately 50 inch outer diameter roll of elastic composite material along the cross or transverse direction from the top of a roll to the core with a utility knife, using three sections of material from the top, the core and a midpoint of the radius as samples. Each sample may be approximately 18 inches by 24 inches and may contain approximately 30 undisturbed layers of composite material, for example. From each of these samples, cut eight 3-inch wide by 7-inch long specimens, with the 7-inch being in the machine direction. Each specimen should contain 2 layers of composite material (with each composite material including an array of continuous filaments positioned between two elastic meltblown layers). Load the upper meltblown layer of one end of the specimen into the upper jaw of a tensile testing unit (Sintech) while loading the lower meltblown layer of the specimen from the same end of the specimen as used for the upper meltblown layer, into the lower jaw of the Sintech unit. Using the method described generally below, use the Sintech tensile tester (manufactured by MTS Systems Corp., model Synergie 200) to measure the average force along the MD length of the material required to separate the two layers, at a 180 degree angle and at a strain rate of 300 mm/min. Test all specimens in the machine direction.

Essentially the test measures the force required to separate two complete layers of elastic composite material from each other (simulating unwinding of composite material from a supply roll). It is considered that such force would be representative of the force necessary to pull a layer of a rolled material off of the roll.

In conducting the test, the individual plies of the composite material (that is one sample of elastic composite material and another) are manually separated for a distance of approximately 2-3 inches to give at least 4 inches of working direction, or separation length. One ply of the sample specimen from the same end of the specimen is clamped into each jaw of the tensile tester and the specimen is then subjected to a constant rate of extension. The edges of the sample are desirably clean cut and parallel. Desirably Sintech TestWorks software can be utilized to acquire data for the system. The grips include 1-inch by 4-inch jaw faces, where the 4-inch dimension is the width of the jaw. The tests are conducted at standard laboratory atmosphere-ambient conditions. The sample of the test should measure from about 3-4 inches in the CD and at least 6 inches in the MD. An appropriate load cell should be chosen such that the peak load value will fall between 10 and 90 percent of the full scale load, 25 lbs or less. Desirably a 5 lb load cell is used. Desirably, where possible, the measurement should be started at about 16 mm and ended up to about 170 mm of elongation. The gage length should be set at about 2 inches (distance between jaws).

What is claimed is:

1. An elastic composite material comprising:
a first elastic meltblown layer comprising an elastic polyolefin-based meltblown polymer having a degree of crystallinity from about 3% to about 40%;
an array of continuous filament strands deposited on the first elastic meltblown layer; and
a second elastic meltblown layer deposited on the continuous filament strands opposite the first elastic meltblown layer;
wherein the elastic composite material is not stretch-bonded.

2. The elastic composite material of claim 1, wherein the elastic polyolefin-based meltblown polymer has a melt flow rate between about 10 and about 600 grams per 10 minutes.

3. The elastic composite material of claim 1, wherein the elastic polyolefin-based meltblown polymer has a melting/softening point between about 40 and about 160 degrees Celsius.

4. The elastic composite material of claim 1, wherein the elastic polyolefin-based meltblown polymer has a density from about 0.8 to about 0.95 grams per cubic centimeter.

5. The elastic composite material of claim 1, wherein the elastic polyolefin-based meltblown polymer comprises at least one of the group consisting of polyethylene, polypropylene, butene, or octene homo- or copolymers, ethylene methacrylate, ethylene vinyl acetate, and butyl acrylate copolymers.

6. The elastic composite material of claim 1, wherein the first elastic meltblown layer comprises at least two layers, with a first layer comprising an elastic polyolefin-based meltblown polymer having a degree of crystallinity between about 3% and about 40% and a second layer comprising a styrenic block copolymer-based meltblown polymer.

7. The elastic composite material of claim 1, further comprising an adhesive that demonstrates a relatively short open time deposited between the array of continuous filament strands and each of the first and second elastic meltblown layers.

8. The elastic composite material of claim 1, wherein the first and second elastic meltblown layers comprise the same elastic polyolefin-based meltblown polymer.

9. The elastic composite material of claim 1, wherein the elastic composite material is incorporated into a personal care article adjacent to an opening for a body part, with no facing layers covering the elastic composite material.

10. An elastic composite material comprising:
a first elastic meltblown layer;
an array of continuous filament strands deposited on the first elastic meltblown layer, wherein the continuous filament strands comprise an elastic polyolefin-based polymer having a degree of crystallinity between about 3% and about 40%; and
a second elastic meltblown layer deposited on the continuous filament strands opposite the first elastic meltblown layer;
wherein the elastic composite material is not stretch-bonded.

11. The elastic composite material of claim 10, wherein the elastic polyolefin-based meltblown polymer has a melt flow rate up between about 10 and about 600 grams per 10 minutes.

12. The elastic composite material of claim 10, wherein the elastic polyolefin-based meltblown polymer has a melting/softening point between about 40 and about 160 degrees Celsius.

13. The elastic composite material of claim 10, wherein the elastic polyolefin-based meltblown polymer has a density from about 0.8 to about 0.95 grams per cubic centimeter.

14. The elastic composite material of claim 10, wherein the elastic polyolefin-based meltblown polymer comprises at least one of the group consisting of polyethylene, polypropylene, butene, or octene homo- or copolymers, ethylene methacrylate, ethylene vinyl acetate, and butyl acrylate copolymers.

15. The elastic composite material of claim 10, wherein the first and second elastic meltblown layers each comprises an elastic polyolefin-based meltblown polymer having a degree of crystallinity between about 3% and about 40%.

16. The elastic composite material of claim 10, wherein the first elastic meltblown layer comprises at least two layers, with a first layer comprising an elastic polyolefin-based meltblown polymer having a degree of crystallinity between about 3% and about 40% and a second layer comprising a styrenic block copolymer-based meltblown polymer.

17. The elastic composite material of claim 10, further comprising an adhesive that demonstrates a relatively short open time deposited between the array of continuous filament strands and each of the first and second elastic meltblown layers.

18. The elastic composite material of claim 10, wherein the elastic composite material is incorporated into a personal care article adjacent to an opening for a body part, with no facing layers covering the elastic composite material.

19. A method of producing an elastic composite material, comprising:
providing a first elastic meltblown layer;
depositing an array of unstretched continuous filament strands on the first elastic meltblown layer; and
depositing a second elastic meltblown layer on the continuous filament strands opposite the first elastic meltblown layer.

20. The method of claim 19, wherein the first elastic meltblown layer comprises an elastic polyolefin-based meltblown polymer having a degree of crystallinity from about 3% to about 40%.

21. The method of claim 19, wherein each of the first and second elastic meltblown layers comprises an elastic polyolefin-based meltblown polymer having a degree of crystallinity from about 3% to about 40%.

22. The method of claim 19, wherein the continuous filament strands comprise an elastic polyolefin-based meltblown polymer having a degree of crystallinity from about 3% to about 40%.

23. The method of claim 19, comprising depositing the second elastic meltblown layer at an add-on up to about 34 grams per square meter.

24. The method of claim 19, comprising depositing the second elastic meltblown layer at an add-on between about 1 and about 5 grams per square meter.

25. The method of claim 19, further comprising calendering the elastic composite material.

26. The method of claim 19, wherein the method does not include calendering the elastic composite material.

27. The method of claim 19, further comprising winding the elastic composite material on a roll.

28. The method of claim 19, comprising extruding the array of unstretched continuous filament strands on the first elastic meltblown layer.

29. The method of claim 19, comprising depositing a plurality of pre-formed continuous filament strands on the first elastic meltblown layer.

30. The method of claim 19, comprising extruding at least one of the first and second elastic meltblown layers.

31. The method of claim 19, wherein at least one of the first and second elastic meltblown layers is pre-formed.
